(19) United States
(12) Patent Application Publication
(10) Pub. No.: US 2012/0079397 A1
(43) Pub. Date: Mar. 29, 2012

(54) SCHEDULING SYSTEM

(75) Inventors: Neta Aizenbud-Reshef, Haifa (IL); Artem Barger, Haifa (IL); Shiri Kremer-Davidson, Yavniel (IL)

(73) Assignee: International Business Machines Corporation, Armonk, NY (US)

(21) Appl. No.: 12/890,669

(22) Filed: Sep. 26, 2010

(51) Int. Cl. G06F 3/00

(52) U.S. Cl. 715/751

(57) ABSTRACT

Method, system, and computer program product for improved scheduling are provided. The method includes: obtaining availability information for a scheduling user and invitees to a new event for a time period; determining if an unavailable time slot is due to a shared event, wherein a shared event is an event between at least one of the invitees and the scheduling user or at least two of the invitees with the scheduling user having access permission to details of the shared event; and displaying the shared event with a visual indication. The visual indication may include displaying information regarding the shared event such as the attendees of the event, the topic of the event, the venue of the event, or a priority of the event.

### BACKGROUND

This invention relates to the field of scheduling systems. In particular, the invention relates to visualizing events in scheduling systems.

Calendar and scheduling systems (referred to herein as scheduling systems) have become widespread in use and provide an automated way of making appointments, accepting or declining appointments, and keeping track of scheduled events including reminders. A user may invite participants to an event via a scheduling system that automatically checks participants' availability for the event.

The scheduling system shows the availability of users in relation to time slots within the days. A user who owns the scheduling system can view all appointments in the calendar. A user who is trying to schedule a event with other users can conventionally see the slots of availability and unavailability of each of the other users. For privacy reasons no additional information is presented.

In the case where the unavailability of other users is due to a shared event between them and the scheduling user, the privacy concern is not applicable as they are all aware of this shared event. The same is true in the case where an event is held among users that allow a scheduling user to see their calendar details.

### BRIEF SUMMARY

According to a first aspect of the present invention there is provided a method for improved scheduling, comprising: obtaining availability information for a scheduling user and invitees to a new event for a time period; determining if an unavailable time slot is due to a shared event, wherein a shared event is an event between at least one of the invitees and the scheduling user or at least two of the invitees with the scheduling user having access permission to details of the shared event; and displaying the shared event with a visual indication; wherein said steps are implemented in either: computer hardware configured to perform said identifying, tracing, and providing steps, or computer software embodied in a non-transitory, tangible, computer-readable storage medium.

According to a second aspect of the present invention there is provided a computer program product for improved calendar scheduling, the computer program product comprising: a computer readable storage medium having computer readable program code embodied therewith, the computer readable program code comprising: computer readable program code configured to: obtain availability information for a scheduling user and invitees to a new event for a time period; determine if an unavailable time slot is due to a shared event, wherein a shared event is an event between at least one of the invitees and the scheduling user or at least two of the invitees with the scheduling user having access permission to details of the shared event; and display the shared event with a visual indication.

According to a third aspect of the present invention there is provided a system for improved scheduling, comprising: a processor; an availability component for obtaining availability information for a scheduling user and invitees to a new event for a time period; a shared event determining component for determining if an unavailable time slot in a calendar is due to a shared event, wherein a shared event is an event between at least one of the attendees and a scheduling user or at least one of the attendees with the scheduling user having access permission to details of the event; and a display component for displaying the shared event with a visual indication.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a schematic diagram of a scheduling system graphical user interface in accordance with the present invention;

FIG. 2A is a block diagram of a first embodiment of a system in accordance with the present invention;

FIG. 2B is a block diagram of a second embodiment of a system in accordance with the present invention;

FIG. 3 is a block diagram of a computer system in which the present invention may be implemented;

FIG. 4 is a flow diagram of a first aspect of a method in accordance with the present invention;

FIG. 5 is a flow diagram of a second aspect of a method in accordance with the present invention; and

FIG. 6 is a flow diagram of a third aspect of a method in accordance with the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

A method, system and computer program product are described in which an extension to a scheduling system visually identifies shared events with a scheduling user and/or other users, for example, in a different color, or using an icon.

A scheduling user is a user wishing to schedule an appointment in a calendar of a scheduling system of one or more other users. When scheduling a new event, a scheduling user is presented with an availability view of available times for the invitees to the new event.

In the described system, an unavailable slot in an availability view which is due to a shared event between the scheduling user and one or more of the invited users, is visually identified in the calendar display. If there are different types of shared events they may be visually identified differently. For example, different types of shared event may include when the scheduling user is part of the shared event or not, or the participants of the shared event are different. The visual identification of the shared event may provide information on the event, for example, a topic, venue, priority, etc.

If there is an event scheduled for users that does not include the scheduling user, if one or more of the users invited to the event allow the scheduling user access their calendar details, then the event can also be visually identified as shared.

The described system eases the task of event scheduling among a group of users. An event may be a meeting, telephone or video conference call, or any other form of event in which there are participants.

Knowing the topic and priority of a shared event from a visual identification, enables the scheduling user to take some informed decisions, such as:
Suggesting changing the topic of the shared event to the topic of the event he is currently trying to schedule and is more important;
Suggesting rescheduling the shared event to a different time, as the slot it occupied is better for the new event, because it is convenient to more people, who are required for the event;
Suggesting adding the discussion topic to the shared event, instead of scheduling an additional event.

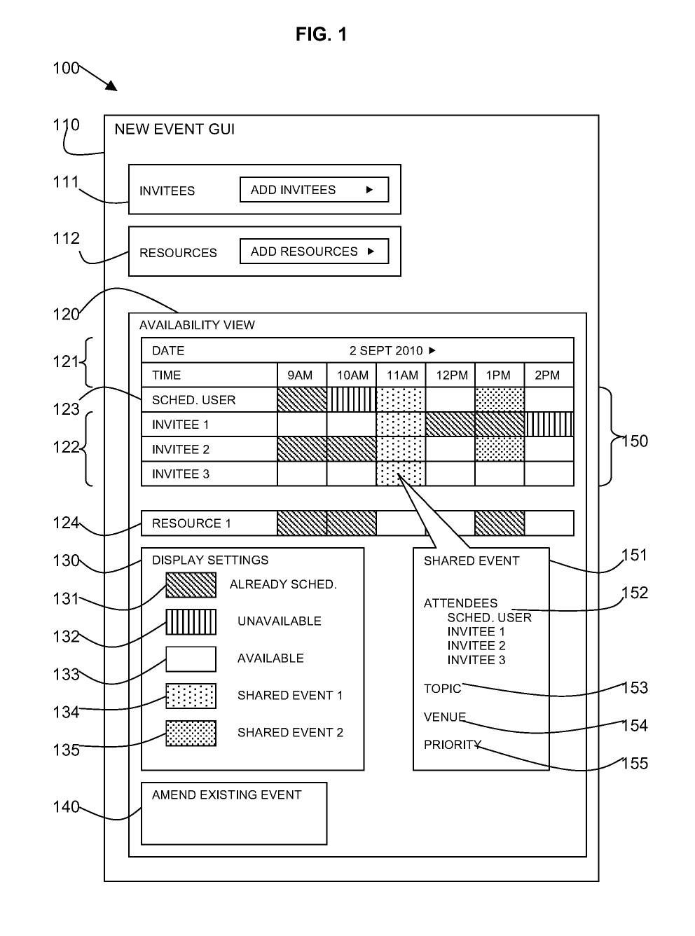

Referring to FIG. 1, there is shown a diagrammatic representation of an example graphical user interface (GUI) 100 of a scheduling system.

A new event GUI 110 within a scheduling system includes field for inputting invitees 111 to the new event, and optionally inputting resources 112 required for the new event. The field for inputting invitees 111 may be linked to an address book and may accept an invitee's name, email, or other identification.

An availability view 120 shows the invitee's availability for a given time period 121. The time period 121 may be selected as a range of hours, a day, a week, etc. The availability view 120 may list the scheduling user 123 and the invitees 122 and may show their availability for each time slot 150 in the time period 121 displayed. For example, the availability may include a different colour or fill pattern for available times, already scheduled times, unavailable times, and other categories such as times where no information is available, and times when the information is restricted.

The invitees 122 may be grouped into those required for the event, and those whose attendance is optional.

Display settings 130 may define the visual indication provided for time slots 150 to indicate their availably. For example, in the illustrated availability view 120 a diagonal striped fill area 131 is used for already scheduled times, a vertical striped fill area 132 is used for unavailable times, and a blank area 133 is used for available times. Two densities of dotted areas 134, 135 are used in the example for different types of shared events, for example, including different participants.

The new event GUI 110 may also include availability for resources 124 such as venues, equipment, etc. The new event GUI 110 may include other optional input fields for the event such as topic, venue, priority rating, etc.

In the described system, a shared event 134, 135 may be visually indicated in the availability view 120 by a different colour, icon, etc. In the illustrated example, two different types of shared events are shown and are visually indicated by a dotted fill patterns of differing density 134, 135. A shared event is defined as an event at which one or more invitees and the scheduling user are attending or have been invited to. A shared event is also defined as an event at which two or more of the invitees are attending or have been invited to but which the scheduling user is not a party but the scheduling user has access permission from at least one of the invitees to the shared event.

Further details 151 of the shared event may be viewed, for example, by a pop-up window when the scheduling user hovers over the time slot 150 of the shared event. The further details 151 may include the attendees 152 of the shared event, the topic 153, the venue 154, the priority 155, etc. Different shared events (such as between different parties) may be visually identified in different ways (for example, with a different colour).

Once a time slot 150 for the new event is selected from the availability view 120, an event invitation may be sent to the invitees with the selected date and time.

An amend existing event option 140 may be provided for a scheduling user to select a shared event and propose an amendment to it.

The described system improves a scheduling system by providing the ability to show shared events, without infringing the privacy of the invitees, using a visual indication, for example, a different color, an icon, etc.

When a scheduling user wants to schedule an event and looks at the availability of the invited users, the system may identify the following events:

(1) Shared with scheduling user—an event is shared between the scheduling user and at least one of the invitees but not all of them;
(2) Shared with all invitees—an event is shared between the scheduling user and all the invitees;
(3) Shared by invitees—an event is shared between some or all of the invitees but without the scheduling user.

In one embodiment, for each unavailable slot the following may be carried out:
If the event that the invitee has in this slot includes the scheduling user as an invitee as well, then instead of showing this slot as unavailable, it is marked as shared (1), and the scheduling user can look into more details about this event (using, for example, a pop-up window that shows the event title and invitee list).
If the invitee has several overlapping events on this slot, where at least one of them does not include the scheduling user as an invitee, then the slot remains shown as unavailable.
If all the invitees have the same event on this slot with the scheduling user, it is marked as shared (2), and the scheduling user can look into more details about this event (using, for example, a pop-up that shows the event title and invitee list).
If some or all the invitees have the same event on this slot without the scheduling user, it is marked as shared (3), but the scheduling user cannot see more details about it.

If a scheduling user has access permission of at least one of the invitees to access their event information, the visual indications may be changed appropriately as if the scheduling user were party to the event.

As an alternative embodiment, instead of visually indicating shared events on an availability view, shared events may be visually indicated on a shared group calendar. If there are events on the shared calendar which are not exposed to all the shared uses, shared events been a group of invitees can be identified as described above.

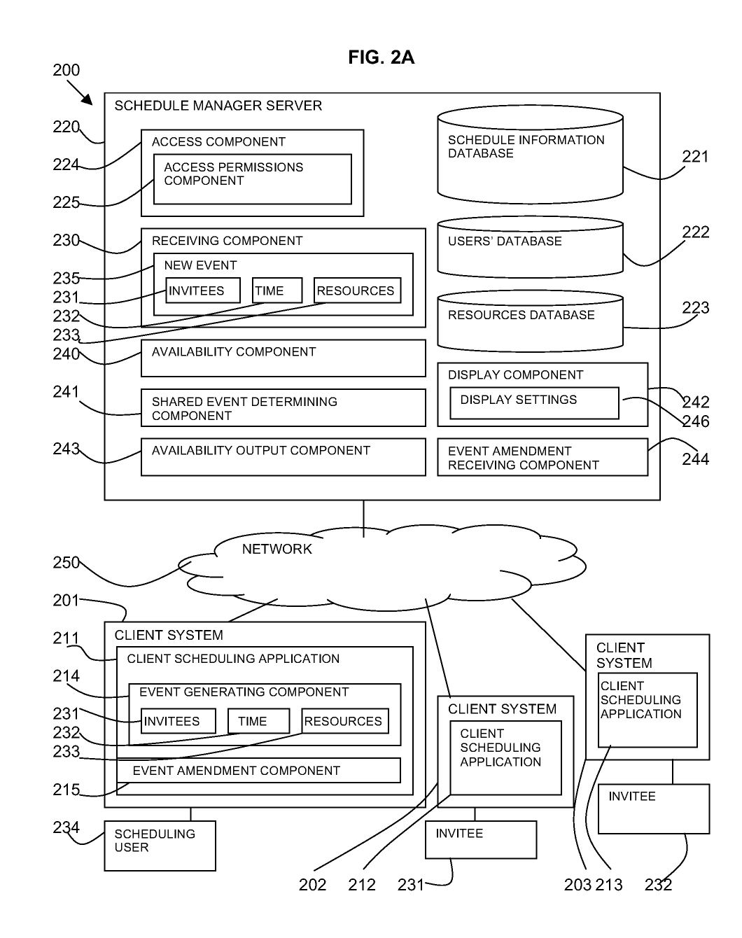

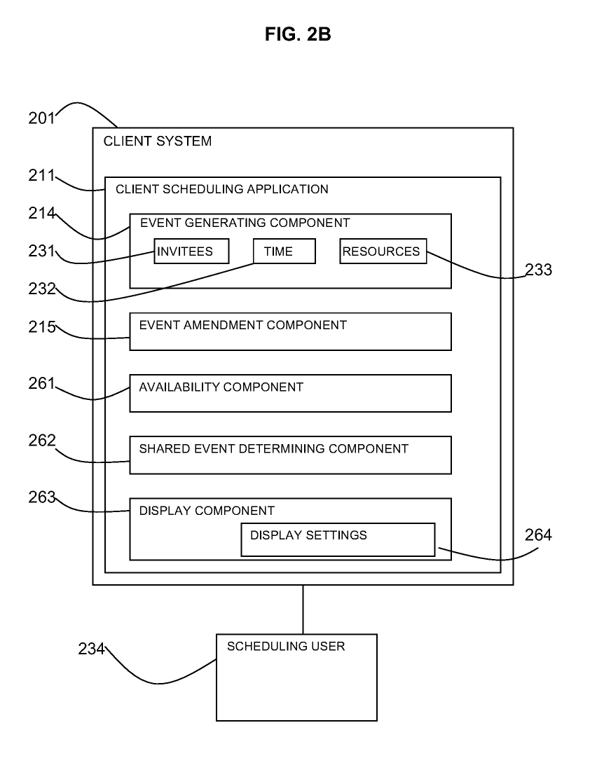

Referring to FIG. 2A, an example embodiment of a scheduling system 200 is shown which may include a schedule manager server 220 in communication via a network 250 with multiple client scheduling applications 211-213 provided on client systems 201-203. The client scheduling applications 211-213 may send and receive messages via client email applications or may be independent of client email applications and may send and receive messages directly or via other communication means.

The schedule manager server 220 may maintain a schedule information database 221 of schedule information of the client scheduling application 211-213. The server 220 may also include a users' database 222 and a resources database 223 for maintaining records of users and resources updates. Any updates to the users' database 222 or resources database 223 may be forwarded to the schedule information database 221.

The server 220 may include an access component 224 for determining client access to the users' database 222 and schedule information database 221. The access component 224 may include an access permissions component 225 in which access permissions for clients to access other clients information are provided.

A scheduling user 234 of a client scheduling application 211 wishing to schedule a new event, uses an event generating component 214 at a client scheduling application 211 to specify invitees 231, a time period 232, and optionally required resources 233.

The server 220 may include a receiving component 230 for receiving details of a new event 235 including details of one or more invitees 231 in the form of other client scheduling application 212-213 users and a time period 232, and optionally required resources 233 from one of the client scheduling applications 211 which is acting as a scheduling user 234. The server 220 may include an availability component 240 for determining from the schedule information database 221 if the invitees 231 are available for the defined time period 232. The availability component 240 may also determine from the schedule information database 221 if required resources 233 are available for the defined time period 232.

The described system may also include a shared event determining component 241 for determining time slots which are unavailable due to a shared event between the one or more of the invitees 231 and the scheduling user 234, or two of more of the invitees 231 without the scheduling user 234, if the scheduling user 234 has access permission to the appointments of at least one of the invitees 231.

A display component 242 may be provided to display shared events with a visual indication as specified in display settings 246 defining the visual indication of shared events as determined by the shared event determining component 241. User settings including the access settings and the display settings may be input by client scheduling applications 211-213 via a GUI and input means.

An availability output component 243 may output the availability for the invitees 231 for the time period 232 and optionally the resource availability 233 to the scheduling user's client scheduling application 211.

The client scheduling application 211 may also include an event amendment component 215 for sending an event amendment request to invitees 231 via the schedule manager server 220.

The schedule manager server 220 may include an event amendment receiving component 244 and may update the users' database 222, scheduling information database 221, and optionally the resources database 223 accordingly.

Referring to FIG. 2B, an alternative embodiment of the described system is provided with processing functionality provided at a client system 201 instead of or in addition to at the server 220.

A client system 201 including a client scheduling application 211 may have a new event generating component 214 for specifying invitees 231, a time period 232, and optionally required resources 233. The client scheduling application 211 may also includes an event amendment component 215. The client scheduling application 211 may include an availability component 261 for receiving and displaying availability for invitees 231 to an event for a time period 232 as supplied by the schedule management server 220 (as shown in FIG. 2A).

In this embodiment, the client scheduling application 211 may include a shared event determining component 262 for determining unavailable time slots that are due to a shared event between the scheduling user 234 and one or more of the invitees 231, or amongst the invitees 231 if the scheduling user 234 has access permission to the appointments of at least one of the invitees 231.

A display component 263 may be provided at the client scheduling application 211 to display shared events according to definitions given in display settings 264 defining the visual indication for shared events.

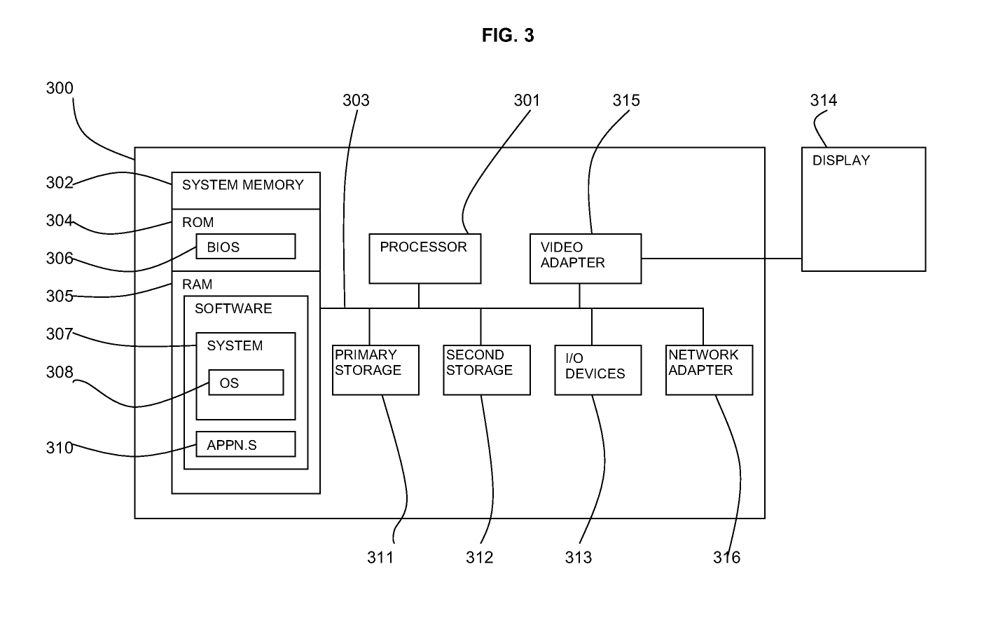

Referring to FIG. 3, an exemplary system for implementing aspects of the invention includes a data processing system 300 suitable for storing and/or executing program code including at least one processor 301 coupled directly or indirectly to memory elements through a bus system 303. The memory elements may include local memory employed during actual execution of the program code, bulk storage, and cache memories which provide temporary storage of at least some program code in order to reduce the number of times code must be retrieved from bulk storage during execution.

The memory elements may include system memory 302 in the form of read only memory (ROM) 304 and random access memory (RAM) 305. A basic input/output system (BIOS) 306 may be stored in ROM 304. System software 307 may be stored in RAM 305 including operating system software 308. Software applications 310 may also be stored in RAM 305.

The system 300 may also include a primary storage means 311 such as a magnetic hard disk drive and secondary storage means 312 such as a magnetic disc drive and an optical disc drive. The drives and their associated computer-readable media provide non-volatile storage of computer-executable instructions, data structures, program modules and other data for the system 300. Software applications may be stored on the primary and secondary storage means 311, 312 as well as the system memory 302.

The computing system 300 may operate in a networked environment using logical connections to one or more remote computers via a network adapter 316.

Input/output devices 313 may be coupled to the system either directly or through intervening I/O controllers. A user may enter commands and information into the system 300 through input devices such as a keyboard, pointing device, or other input devices (for example, microphone, joy stick, game pad, satellite dish, scanner, or the like). Output devices may include speakers, printers, etc. A display device 314 is also connected to system bus 303 via an interface, such as video adapter 315.

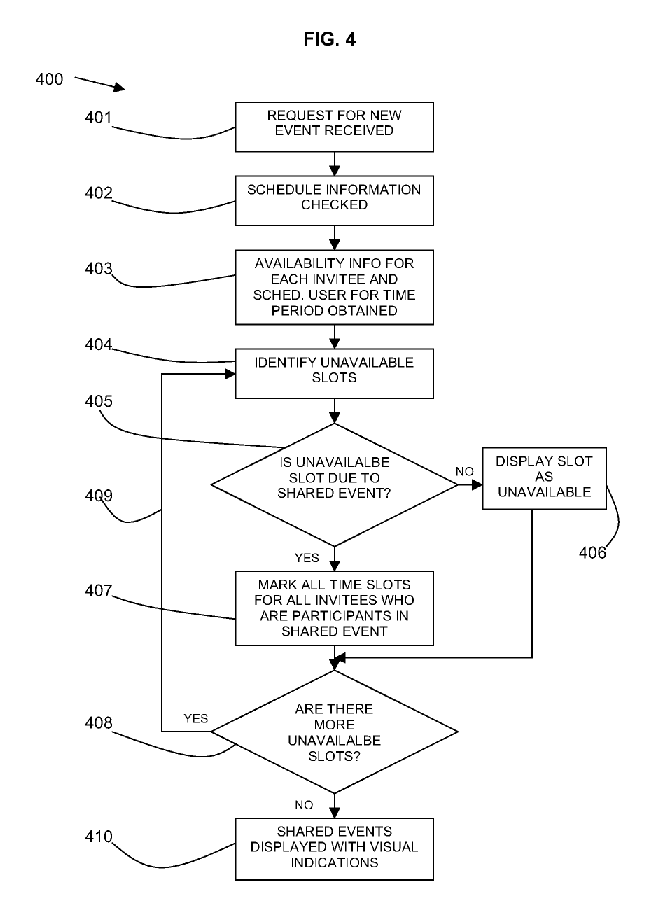

Referring to FIG. 4, a flow diagram 400 shows an embodiment of the described method as provided at a scheduling management server.

A request for a new event is received 401 at the server including an indication of the scheduling user, a list of invitees, and a time period. Optionally, required resource availability can also be received.

The schedule information maintained by the server is checked 402 for the scheduling user and each of the invitees for the time period and the availability information is obtained 403.

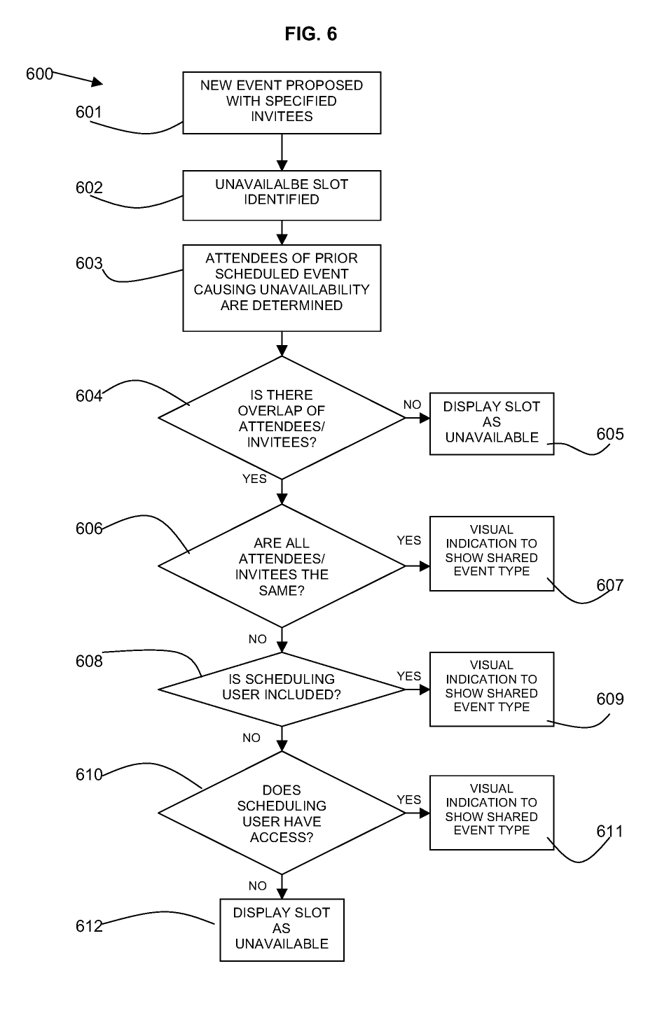

Unavailable slots are identified for the scheduling user and the invitees 404. It is determined 405, if an unavailable slot is due to a shared event. The server looks deeper into the events of the scheduling user and the invitees and the participants of its events to identify shared events. This step is described further in relation to the flow diagram 600 of FIG. 6.

If it is not a shared event, the slot may be displayed 406 conventionally as unavailable. If it is a shared event, the time slots for all the invitees who are participants of the shared event may all be marked 407 as a shared event.

It may be determined 408, if there are more unavailable slots of the scheduling user or invitees. If so, the process loops 409 to the next unavailable slot.

If not, the process ends and the shared events may be displayed 410 with visual indications as described above.

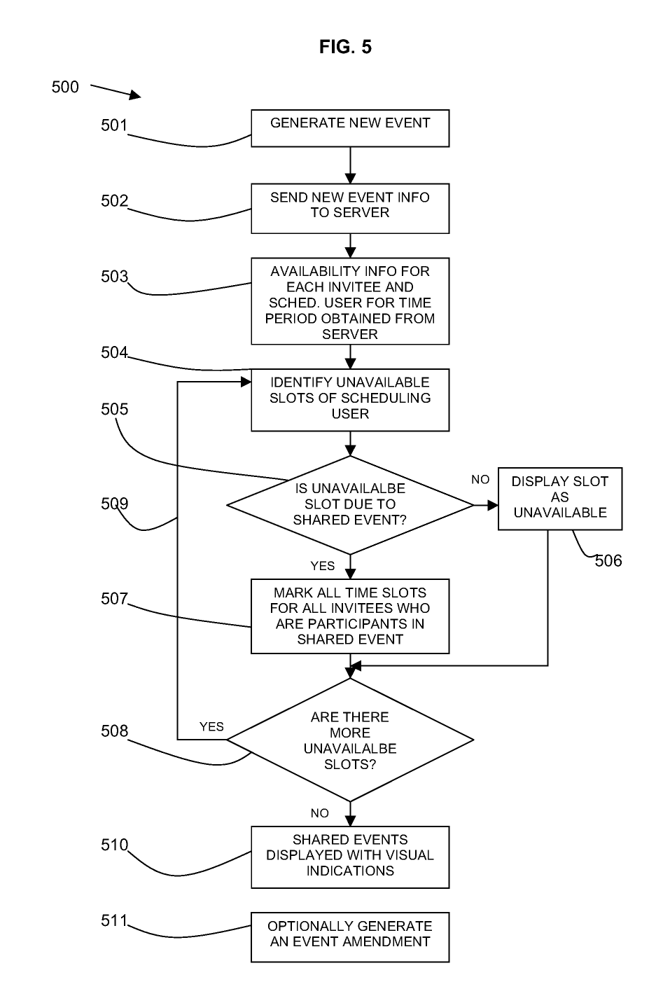

Referring to FIG. 5, a flow diagram 500 shows an embodiment of the described method at a client scheduling application.

A client scheduling application generates a new event 501 defining invitees and a time period. The new event information is sent 502 to the server and availability information is obtained 503, for example, as received from the server for the scheduling user and the invitees.

Unavailable slots of the scheduling user are identified 504. It is determined 505, if an unavailable slot is due to a shared event. The client application looks deeper into the events of the scheduling user and the participants of its events to identify shared events with other invitees to the current event. This step is described further in relation to the flow diagram 600 of FIG. 6.

If it is not a shared event, the slot may be displayed 506 conventionally as unavailable. If it is a shared event, the time slots for all the participants of the shared event may all be marked 507 as a shared event.

It may be determined 508, if there are more unavailable slots of the scheduling user. If so, the process loops 509 to the next unavailable slot.

If not, the process ends and the shared events may be displayed 510 with visual indications as described above.

The scheduling user may generate 511 an event amendment to amend an existing shared event.

Referring to FIG. 6, a flow diagram 600 shows an embodiment of determining if an unavailable time slot for a user is a shared event. The described steps may be performed in a different order or may be different if different shared events are defined.

A new event is proposed 601 by a scheduling user with identified invitees. An unavailable time slot is identified 602 for a user, wherein the user is the scheduling user or one of the invitees. The attendees of the prior scheduled event causing the unavailability are determined 603.

It may be determined 604 if the attendees of the event causing the unavailability and the scheduling user and invitees to the new event overlap by at least two participants. If they do not overlap, the slot may be displayed as unavailable 605. If they do overlap, it is determined 606 if all the attendees/invitees are the same. If so, a defined visual indication may be applied 607 to show a shared event with all the same participants. The visual indication may be applied in the availability view of all the attendees/invitees.

If not all the attendees/invitees are the same, it may be determined 608 if the scheduling user is included. If the scheduling user is included, a defined visual indication may be applied 609 to show a shared event with the scheduling user and at least one of the invitees. The visual indication may be applied in the availability view of the scheduling user and the at least one invitee.

If the scheduling user is not included, it may be determined 610 if the scheduling user has access permission from at least one of the attendees of the event causing the unavailability. If there is permission, a defined visual indication may be applied 611 to show a shared event without the scheduling user but with at least two of the invitees. The visual indication may be applied in the availability view of the at least two invitees.

If the scheduling user does not have permission, the unavailable slot may remain 612 marked as unavailable. Alternatively, the a shared event between two or more of the invitees without the scheduling user may be marked as a type of shared event but without the scheduling user having the ability to see any further details of the event.

A scheduling user may then send a proposed amendment to an existing shared event to attendees, for example, to change the topic, add a topic, etc.

A scheduling system may be provided as a service to a customer over a network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for improved scheduling, comprising:
obtaining availability information for a scheduling user and invitees to a new event for a time period;
determining if an unavailable time slot is due to a shared event, wherein a shared event is an event between at least one of the invitees and the scheduling user or at least two of the invitees with the scheduling user having access permission to details of the shared event; and
displaying the shared event with a visual indication;
wherein said steps are implemented in either:
computer hardware configured to perform said identifying, tracing, and providing steps, or
computer software embodied in a non-transitory, tangible, computer-readable storage medium.

2. The method as claimed in claim 1, wherein displaying the shared event with a visual indication displays the visual indication in slots of all attendees of the shared event who are invitees to the new event.

3. The method as claimed in claim 1, wherein displaying the shared event with a visual indication includes displaying the slot of an invitee with one or more of the group of: a different colour, icon, pattern.

4. The method as claimed in claim 1, wherein displaying the shared event with a visual indication includes displaying information regarding the shared event, wherein the information regarding the shared event includes one or more of the group of: the attendees of the event, the topic of the event, the venue of the event, a priority of the event.

5. The method as claimed in claim 1, including:
providing an availability view of all invitees and the scheduling user of the new event including the display of shared events.

6. The method as claimed in claim 1, including:
inputting settings regarding the display of shared events and regarding access permissions for a scheduling user.

7. The method as claimed in claim 1, wherein determining if an unavailable time slot is due to a shared event is carried out at a scheduling server and determines unavailable time slots of each of the scheduling user and the invitees.

8. The method as claimed in claim 1, wherein determining if an unavailable time slot is due to a shared event is carried out at a scheduling client and determines unavailable time slots of the scheduling user.

9. The method as claimed in claim 1, including:
proposing amendment of a shared event in favour of the new event.

10. The method as claimed in claim 9, wherein an proposing amendment includes one or more of the group of: changing the topic of an exiting event, rescheduling an existing event to a different time; adding a topic to an existing event.

11. A computer program product for improved calendar scheduling, the computer program product comprising:
a computer readable storage medium having computer readable program code embodied therewith, the computer readable program code comprising:
computer readable program code configured to:
obtain availability information for a scheduling user and invitees to a new event for a time period;
determine if an unavailable time slot is due to a shared event, wherein a shared event is an event between at least one of the invitees and the scheduling user or at least two of the invitees with the scheduling user having access permission to details of the shared event; and
display the shared event with a visual indication.

12. A system for improved scheduling, comprising:
a processor;
an availability component for obtaining availability information for a scheduling user and invitees to a new event for a time period;
a shared event determining component for determining if an unavailable time slot in a calendar is due to a shared event, wherein a shared event is an event between at least one of the attendees and a scheduling user or at least one of the attendees with the scheduling user having access permission to details of the event; and
a display component for displaying the shared event with a visual indication.

13. The system as claimed in claim 12, wherein the display component includes an information display for displaying information regarding a shared event, wherein the information regarding the shared event includes one or more of the group of: the attendees of the event, the topic of the event, the venue of the event, a priority of the event.

14. The system as claimed in claim 13, wherein the information display is a graphical user interface window.

15. The system as claimed in claim 12, wherein the display component includes a graphical user interface availability display for multiple invitees and the scheduling user with availability for a time period.

16. The system as claimed in claim 12, including a display settings component for inputting settings regarding the display of shared events.

17. The system as claimed in claim 12, including an access component for allowing access to invitees appointments to a scheduling user.

18. The system as claimed in claim 12 provided at a scheduling server, wherein the availability component obtains availability information from a scheduling information database in response to receipt of a new event from a scheduling client.

19. The system as claimed in claim 12 provided at a scheduling client, wherein the availability component receives availability information from a scheduling server in response to a new event request.

20. The system as claimed in claim 12, including:
a new event generating component at a scheduling client defining invitees to the proposed event and a time period.

21. The system as claimed in claim 12, including:
an existing event amendment component at a scheduling client for proposing an amendment to a shared event.
